(19) United States
(12) Patent Application Publication
(10) Pub. No.: US 2022/0411180 A1
(43) Pub. Date: Dec. 29, 2022

(54) Non-corrosive, Double Gooseneck, Gaseous Pressure Equalization Vent for Large Liquid Storage Tanks

(71) Applicants: James Wilford Angelo, IV, Centerville, TX (US); Ashley Marie Angelo, Centerville, TX (US)

(72) Inventors: James Wilford Angelo, IV, Centerville, TX (US); Ashley Marie Angelo, Centerville, TX (US)

(21) Appl. No.: 17/896,408

(22) Filed: Aug. 26, 2022

(51) Int. Cl. B65D 90/34; B29C 33/00; B29C 33/76

(52) U.S. Cl. CPC B65D 90/34; B29C 33/0033; B29C 33/76; B65D 2590/22; B29K 2027/06

(57) ABSTRACT

A vent structure for large volume liquid storage tanks having a double gooseneck shape with vent openings facing downward, formed as a single structure from a mold tool with multipart extractable cores for forming the structure from corrosive resistant materials without a need for substantial post machining.

### BACKGROUND OF THE INVENTION

### Cross-Reference to Related Applications

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### TECHNICAL FIELD

The present invention relates to vents for liquid storage tanks. More particularly, the invention relates to manufacturing of large venting structures for large water storage tank application.

### BACKGROUND OF THE INVENTION

With liquid storage tanks, a vent is required so atmosphere within the storage tank can freely communicate with ambient atmosphere external to the storage tank, preventing any pressure differential being compressed or expanded. It is important that the venting not be impeded by ambient weather conditions. Pressure changes can occur if heavy winds are directly into or away from a single opening or passing across vent openings. For this reason, multiple openings are preferred.

Storage tanks, particularly those for potable water, should be protected against unwanted matter and/or organisms entering the contents of the storage tank through vent openings. When water storage tank vents are not properly protected or their protection devices fail insects, birds, other organisms, and/or general trash may enter the drinking water within the storage tank creating a potential health hazard.

Commonly these vents are located on the roof of large tanks. The Environmental Protection Agency (EPA) and other governmental agencies regulate various aspects of these tanks, including functional and structural components further complicating the engineering of their implementations. The vents must allow air to enter and flow from the storage tank interior at quantities sufficient to prevent pressure differentials, which are significant at peak operation of such tanks. This can often require vents more than twelve inches in diameter.

Ambient weather, such as high winds and rains, can impede functionality of venting. For this reason, the double goose neck vent has been a long-preferred design. The downward facing openings prevent rain and wind from blowing into the openings and for this reason are required under current federal regulations. The design's dual openings, positioned on opposing sides of a central standpipe, ensure high winds do not cause vacuum effects, or opposing pressures, providing a relative ambient atmosphere at the tank-mating joint.

To add further protection from contamination, mesh screen is often attached with support elements around outer vent cover openings. This prevents the entry of insects, animals, and other trash to the tank's interior. The difficulty with this type of vent cover is that the screens and other components are known to fail due to the corrosive environment often found in and near a storage tank.

While a traditional double gooseneck vent can be fabricated with a tee-join and a couple of 90-degree elbows, such fittings are generally rare and/or cost prohibitive for pipe diameters in the range of 6 to 12 inches, much less the even larger diameters required to sufficiently vent the larger storage tanks referenced herein. For this reason, the required larger vents (generally >6 inches in diameter) have been fabricated by metal casting or built completely from metal sheet materials.

### BRIEF DESCRIPTION OF THE DRAWINGS

FIG. 1 illustrates a tee-shaped double gooseneck vent manufactured of non-corrosive materials in accordance with an exemplary embodiment of the innovation.

FIG. 2 shows an alternative embodiment of a double gooseneck vent molded from a non-corrosive material in accordance with an exemplary embodiment of the innovation.

FIG. 3 shows the cross-sectional view indicated in FIG. 2 above.

FIGS. 4 and 5 show a configuration for arranging and maneuvering core forms for molding double gooseneck vents from non-corrosive material in accordance with an exemplary embodiment of the innovation.

### DETAILED DESCRIPTION OF THE PREFERRED EMBODIMENTS

The novel features believed characteristic of the innovation are set forth in the appended claims. The innovation itself, however, as well as a preferred mode of use, further objectives, and advantages thereof, will be best understood by reference to the following detailed description of illustrative embodiments when read in conjunction with the accompanying drawings.

The innovation described employs the technology of plastic welding to construct a double gooseneck vent from plastic, a substantially inert material, resulting in corrosive resistant vents with reduced maintenance needs, longer functional lifetime, and lighter weight/less stress on a tank structure. The vents have downward turned openings at distal ends of a crossbar pipe. The downward turned ends are terminated by flanges, end flanges, with holes, clips, or other mount points for securing exclusion flanges with a screened center opening, a screen flange, preventing intrusion of insects, animals, and/or other contaminants.

In the preferred embodiment a schedule 40 PVC (a Polyvinyl Chloride thermoplastic) pipe in diameter ranges of 18-26 inches is used along with flat sheets of similar material and thicknesses. However, one skilled in the arts would appreciate that other materials, having different specifications but similar structural characteristics, can be employed in the manufacture while exemplifying the teachings herein. Flanges are cut from flat sheets of the corrosive resistant materials and joined to the ends of pipe by epoxy or using plastic welding, a spin weld, to create molecular bonding strengths in the joints substantially equal to those of the native material.

Distil ends of the downpipes are notched and joined, via epoxy adhesive or plastic welding, to opposite ends of a crossbar pipe, the center of which is notched and joined to the top of a standpipe. The standpipe lower end is terminated by a flange, a bottom flange, which optionally includes structural supports extending upwards from the flange's top surface along the standpipe outside wall and structurally joined thereto.

Optional structural supports may be employed and thereby permit use of thinner construction materials, or higher durability, which may be required to service implementations in areas with adverse conditions. A flange, particularly one of standardized pipe fitting configuration, on the bottom of the standpipe provides backwards compatibility with traditional flanged vent openings found on many large fluid storage tanks.

The preferred method of joining the plastic vent components is by employing a plastic welding process (a spin weld) comprised of heating, pressing, and swirling to mix the softened material edges of the joined components and optionally adding filler or donor materials as needed before cooling. However, other joining options may include, but is not limited to molding in place; epoxying; using fasteners, dove-tailing or other notching; or could be comprised of a combined plurality of the proceeding.

As state above, a traditional double gooseneck vent was fabricated from metal piping, resulting in weight issues, or sheet metal materials resulting in corrosion issues. Plastic welding and/or other joining techniques allows for the use of non-metallic materials and the retention of traditional flanges at the openings allows for backwards compatibility for retrofitting existing tanks.

In an alternative embodiment, the two downpipes and the crossbar pipe are combined into a single curving half circle extending across, and joining in the middle, to the standpipe. The curving crossbar pipe in the preferred embodiment is formed by injection molding. The mold tool (a.k.a. the mold ‘form’) comprises cavities for shaping the walls and flanges with withdrawable cores forming the hollow interior for the standpipe opening and both downpipes.

The core of each downpipe is comprised of a plurality of sections centrally joined along their axis in a rotational fashion, end to end, forming each vent path's full core. This allows each downpipe's core to be partially withdrawn, after which the withdrawn portion is rotated from the cavity's predominant plane, allowing further withdrawal of the remaining sections into the alternate plane, and preventing issues of interference with any other cores.

A raised rim around the core's end-face that matches to a groove in the mating face of an adjacent core end helps seal core section joints during forming and assist in relative motions there between.

### DETAILED DESCRIPTION OF THE DRAWINGS

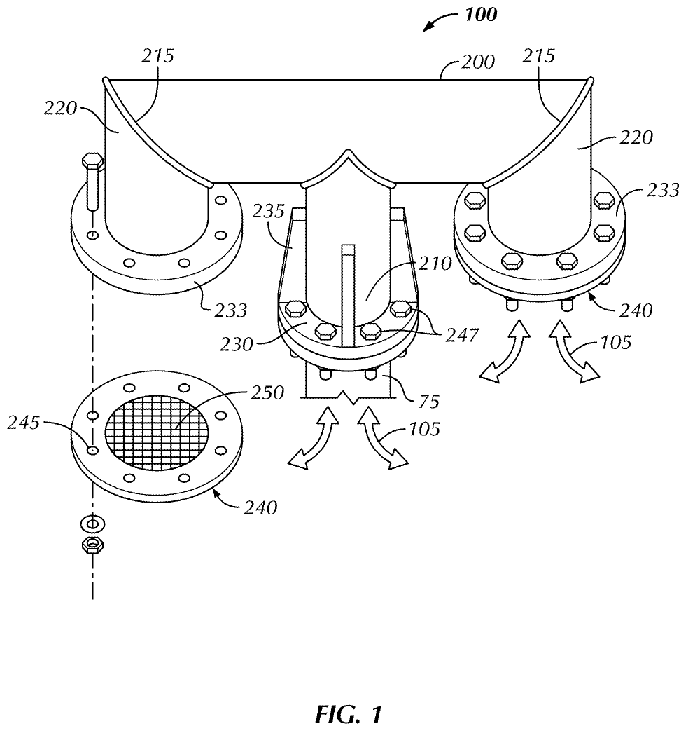

FIG. 1 illustrates a tee-shaped double gooseneck vent manufactured of non-corrosive materials in accordance with an exemplary embodiment of the innovation. To manufacture, from non-corrosive tubular material, a double goose-neck vent (100), while preserving the ‘tee-shape’ configuration, the crossbar pipe (200) is joined to two downpipes (220) using a plastic weld or epoxy joint (215).

A similar connection mates the crossbar pipe (200) to the standpipe (210). Optionally, the use of rib supports (235) may provide additional structural support or permit thinner construction materials. A bottom flange (230), ideally configured to pipe fitting standards for backward compatibility, is mounted to the lower end of the standpipe (210). The standpipe (210) and the bottom flange (230) may be reinforced with rib supports, structural supports (235) extending upwards from the bottom flange's top surface along the standpipe's (210) outside wall and structurally joined thereto.

Employing structural supports (235) permits thinner construction materials, or results in a higher durability, which may be required to service implementations in areas with adverse conditions. The distal ends of the two downpipes (220) are terminate with end flanges (233), ideally configured to pipe fitting standards, to the extend necessary, for backward compatibility.

This allows joining of the bottom flanges (230) to the storage tank (50—not illustrated) flanged vent opening (75), for example, but not limited to, with fasteners (247). End flanges (233) also having standard bold configurations also allows protection of vent openings (105) with a screened flange (240), which has a screened opening (250), and bolt holes (245) for joining to one of the vents (200) downpipe (220) end flanges (233).

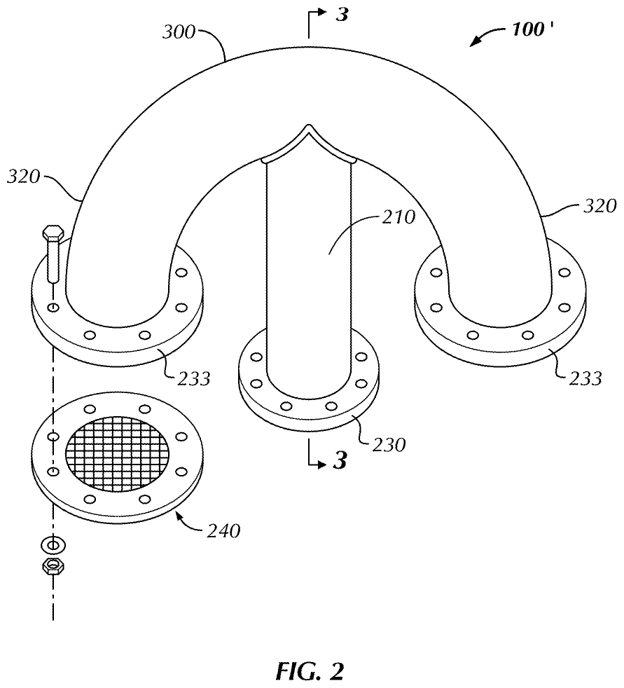

FIG. 2 shows an alternative embodiment of a double gooseneck vent molded from a non-corrosive material in accordance with an exemplary embodiment of the innovation. To permit molding from tubular non-corrosive material, a double goose-neck vent (100′) is comprised of a curved crossbar pipe (300) centrally joined to the upper end of a standpipe (310) and extending therefrom in a downward curve to form at distal ends two downpipes (320).

Bottom flanges (230) terminating the standpipe's (310) lower end may optionally include rib supports as described and shown above. The distal ends of the crossbar pipe (300), here identified as the two downpipes (320), are terminated with end flanges (233). As stated above, flanges (230 & 233) are ideally configured to pipe fitting standards, as much as necessary for safe operation and backward compatibility. This includes, as described above, the flanges (230 & 233) having standard bold configurations. This facilitates protection of downpipe (320) openings with screened flanges (240).

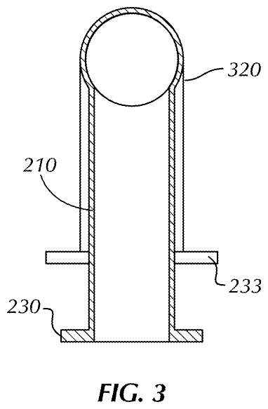

FIG. 3 shows the cross-sectional view indicated in FIG. 2 above. One side of the crossbar pipe (320) and its end flange (233) can be seen behind the standpipe (210) and bottom flange (230).

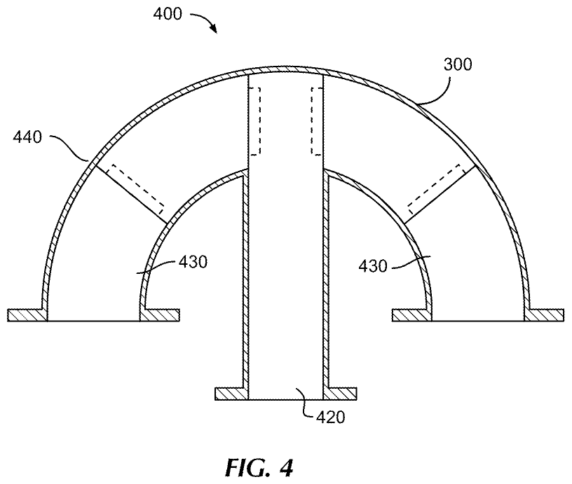

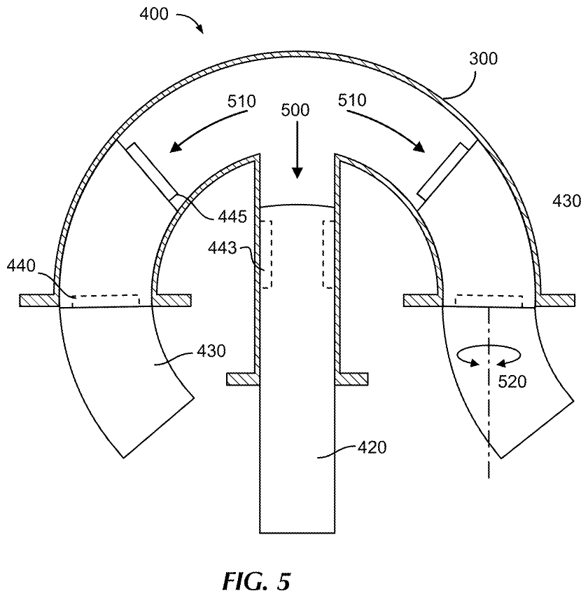

FIGS. 4 and 5 show a configuration arranging and maneuvering core forms for molding double gooseneck vents from non-corrosive material in accordance with an exemplary embodiment of the innovation. For clarity, only the relevant innovative components of a mold tool are illustrated herein. One skilled in the art will appreciate the need for tapering, alignment, guide pins, cooling channels, runners, gates, ejection components, etc. for complete functional mold tool designs in injection molding operations.

A typical mold tool minimizes joints and movements which cause flashing issues and complicate alignment during opening and closing operations. Due to the curve necessary in the crossbar pipe/downpipe (300) of a molded double gooseneck vent (100′), mold tool (400) core (420 and 430) interference prevents withdrawal of the cores (420 and 430) from the interior of the molded vent (100′) and from the mold cavity (410, not shown) after forming/molding.

To eliminate interference upon withdrawing interior cores (420 and 430), the crossbar pipe/downpipe core is comprised of a plurality of mating core sections (430). The mating faces of the cores (420 and 430) further comprises interlocking joints (440) comprised of recessed channels (443) on one face and matching embossed ridges (445) on the opposing face. These joints help prevent flashing issues. In the preferred embodiment of the core sections (430) the ridges and channels are circular, and the cores are rotatably joined along their axis to allow extraction as a unit, and to guide rotation (520) of the sections relative to each other.

To open the mold tool, the standpipe core (420) is extracted (500) from the molded vent (100′) and the mold cavity (410) along its central axis. But extracting (510) the core sections (430) requires each core section be rotated out of the mold tool's primary axis. In another embodiment, the mating faces of the standpipe and the adjacent core sections may be angled toward the standpipe's central axis to accommodate differing diameters such as that shown in the cross section, (FIG. 3).

Figs in accordance with exemplary embodiments of the present innovation are provided as examples and should not be construed to limit other embodiments within the scope of the invention. For instance, heights, widths, and thicknesses may not be to scale and should not be construed to limit the invention to the proportions illustrated. Additionally, some elements illustrated in the singularity may be implemented in a plurality. Some element illustrated in the plurality could vary in count. Elements are not confined to the illustrated form but could vary in detail.

The above discussion is meant to be illustrative of the principles and various embodiments of the present innovation. Numerous variations and modifications will become apparent to those skilled in the art once the above disclosure is fully appreciated. It is intended that the following claims be interpreted to embrace all such variations and modifications.

What is claimed is:

1. A vent structure for a large volume liquid storage tank, comprising:
a bottom flange;
a standpipe joined at one end to the bottom flange,
wherein the bottom flange has a central opening to allow gaseous flow between an atmosphere in the storage tank and an atmosphere within the vent structure;
the standpipe's distal end joined and opening into the side of a crossbar pipe at the approximate length's center, allowing gaseous flow there between; both ends of which extend to;
an end flange,
wherein the end flange is a vent opening allowing gaseous flow between the atmosphere within the vent structure and the exterior environment;
the vent structure being constructed as a single unit comprised of a substantially inert corrosion resistant material.

2. The vent structure of claim 1 further comprised by:
a plurality of structural supports joined to:
the top face of the bottom flange and
the outside surface of the standpipe.

3. The vent structure of claim 1 wherein the vent openings are oriented to open downward.

4. The vent structure of claim 2 wherein orienting the vent openings to open downward comprises:
curving the crossbar pipe ends, extending from the standpipe, so the end flanges open downward.

5. The vent structure of claim 2 wherein orienting the vent openings to open downward comprises:
a substantially straight crossbar pipe oriented horizontally and
vertically oriented downpipe, wherein:
the upper end of the downpipe joined to one end of the crossbar pipe;
the end flange joined to the distal end;
opening downward; and
allowing gaseous flow there between.

6. The vent structure of claim 1 wherein the construction comprises:
joining by spin weld the vent structure into a single unit.

7. The vent structure of claim 1 wherein the construction comprises:
joining with adhesive the vent structure into a single unit.

8. The vent structure of claim 1 wherein the construction is by molding the vent structure as a single unit.

9. The vent structure of claim 1 wherein substantially inert corrosive resistant material is a plastic.

10. The vent structure of claim 9 wherein the plastic is a thermoplastic.

11. The vent structure of claim 9 wherein the plastic is polyvinyl chloride thermoplastic, commonly known as PVC.

12. A mold tool for molding a vent structure for a large volume liquid storage tank comprising:
upper and lower mold cavities,
a standpipe core, and
a plurality of curved mating core sections;
producing the vent structure,
wherein the vent structure comprises:
two end flanges, and
a bottom flange,
wherein each flange, is ring-shaped, comprised of:
a disk, and
a central opening extending between, and passing through upper and lower faces of the disk,
a standpipe extending between and connecting the central opening of the bottom flange, to
the sidewall of, and open internally to, a perpendicularly oriented crossbar pipe,
the crossbar extending substantially equal distances
in two opposite directions from the standpipe's center axis, and
connecting central openings of two end flanges; and
wherein the central opening of the flanges are in gaseous communication with each of the other flanges through the standpipe and the crossbar.

13. The mold tool of claim 12 wherein:
one end of the standpipe core removably adjoins at least one of the curved mating core sections,
the distal end of the standpipe core passing through a bottom flange cavity, and
removably extractable from molded vent structures through the bottom flange of the structure; and
two end cores wherein each end core:
comprises a plurality of the curved mating core sections,
rotatably joined together,
passing through end flange cavities,
removably extractable from molded vent structures through the end flanges of the structure;
the extracted cores forming a central opening through the molded vent structures;
wherein the central opening of each extracted core is in gaseous communication with each of the other central openings from each other extracted core.

14. The mold tool of claim 12 wherein each flange is further comprised of:
a plurality of bolt holes equally spaced, around and extending through the flange ring parallel to the central opening.

15. The mold tool of claim 12 wherein the upper and lower cavities further comprise:
a plurality of cavities forming structural supports extending:
from the top face of the bottom flange,
to the outside surface of the standpipe.

16. The mold tool of claim 12 wherein the vent structure is produced as a single unit.

17. The mold tool of claim 12 wherein:
one end of the standpipe core removably adjoins at least one of the curved mating core sections,
the distal end of the standpipe core passing through a bottom flange cavity, and
removably extractable from molded vent structures through the bottom flange of the structure; and
two end cores wherein each end core:
comprises a plurality of the curved mating core sections,
rotatably joined together,
passing through end flange cavities,
removably extractable from molded vent structures through the end flanges of the structure;
the extracted cores forming a central opening through the molded vent structures;
wherein the central opening of each extracted core is in gaseous communication with each of the other central openings from each other extracted core.

18. The mold tool of claim 12 wherein the vent structure comprises a substantially inert corrosion resistant material.

19. The mold tool of claim 18 wherein the inert corrosive resistant material is a plastic.

20. The vent structure of claim 19 wherein the plastic is polyvinyl chloride thermoplastic, commonly known as PVC.
